(19) United States
(12) Patent Application Publication
(10) Pub. No.: US 2008/0160127 A1
(43) Pub. Date: Jul. 3, 2008

(54) DOUGH DIVIDER

(76) Inventors: Bill E. Davis, Irving, TX (US); Austin J. Kozman, Dallas, TX (US)

Correspondence Address: Michael A. O'Neil;Michael A. O'Neil, P.C., Suite 820, 5949 Sherry Lane, Dallas, TX, 75225, US

(21) Appl. No.: 11/966,477

(22) Filed: Dec. 28, 2007

Related U.S. Application Data
(60) Provisional application No. 60/883,085, filed on Jan. 2, 2007.

(51) Int. Cl. A21C 5/02

(52) U.S. Cl. 425/239

(57) ABSTRACT

A dough divider comprises a dough receiving hopper, a pressurizing chamber positioned beneath the hopper, a manifold positioned beneath the pressurizing chamber, a plurality of cut off heads positioned beneath the manifold, and a cut off knife assembly positioned beneath the cut off heads. At least one auger is positioned within the hopper for forcing dough received therein into the pressurizing chamber. Pressure applied to the dough within the pressurizing chamber releases CO² therefrom. The manifold provides uniform distribution of the dough to all of the cut off heads. The cut off heads form the dough into a plurality of dough streams comprising individually regulated diameters. The cut off knife assembly severs the dough streams into equal length dough balls thereby producing dough balls that are substantially identical in weight.

### CROSS-REFERENCE TO RELATED APPLICATION

This application claims priority based on provisional application Ser. No. 60/883,085 filed Jan. 2, 2007, the entire contents of which are incorporated herein by reference.

### TECHNICAL FIELD

This invention relates generally to dough dividers of the type utilized in the commercial baking industry, and more particularly to a dough divider useful in the processing of doughs having a wide range of consistencies.

### BACKGROUND AND SUMMARY OF THE INVENTION

Numerous dough dividers intended for use in the commercial baking industry have been designed and patented heretofore. Notwithstanding the considerable effort and investment that has been expended in dough divider development two deficiencies continue to characterize virtually all dough divider designs.

First, existing dough dividers are designed and manufactured for use with specific dough consistencies. The result is that a dough divider designed for use in processing, for example, bun dough may not be able to be used in the processing of dough having a different consistency, for example, tortilla dough. Therefore, should a bakery that has been manufacturing products such as hot dog and hamburger buns decide to introduce a new pro duct such as tortillas the bakery must incur the expense and delay inherent in purchasing an entirely new dough divider.

Second, most existing dough dividers are horizontally oriented. Because horizontally oriented dough dividers cannot utilize gravity to effect dough movement, the dough must be pumped therethrough. As is well known to those skilled in the art, pumping of dough nuts more work into the dough resulting in an undesirable increase in dough temperature.

The present invention comprises a dough divider design which overcomes the foregoing and other problems which have long since characterized the prior art. The dough divider of the present invention processes dough without significantly increasing the temperature thereof thereby producing dough balls that are considerably superior to the dough balls produced by prior art dough dividers. Additionally, the dough divider of the present invention is adapted to the processing of a wide range of dough consistencies including those utilized in all of the products typically manufactured by commercial bakeries.

### BRIEF DESCRIPTION OF THE DRAWINGS

A more complete understanding of the present invention may be had by reference to the following Detailed Description when taken in connection with the accompanying Drawings, wherein:

FIG. 1 is a front view of a dough divider comprising a first embodiment of the present invention in which certain component parts have been broken away more fully to illustrate the construction and operation of the dough divider;

FIG. 2 is a side view of the dough divider of FIG. 1 in which certain component parts have been broken away more fully to illustrate the construction and operation of the dough divider;

FIG. 3 is a side view of a cut off head utilized in the dough divider of FIGS. 1 and 2 in which certain component parts have been broken away more fully to illustrate the construction and operation of the cut off head;

FIG. 4 is a sectional view taken along the line 4-4 in FIG. 3 in the direction of the arrows;

FIG. 5 is a sectional view taken along the line 5-5 in FIG. 3 in the direction of the arrows;

FIG. 6 is a bottom view of a cut off blade assembly utilized in the dough divider of FIGS. 1 and 2;

FIG. 7 is a top view of a metering pump useful in conjunction with the dough divider of FIGS. 1 and 2 in which certain parts have been broken away more fully to illustrate certain features thereof;

FIG. 8 is a sectional view taken along the line 8-8 in FIG. 7 in the direction of the arrows;

FIG. 9 is a perspective view further illustrating the metering pump of FIGS. 7 and 8;

FIG. 10 is a view similar to FIG. 1 illustrating the metering pump of FIGS. 7, 8, and 9 installed in the dough divider thereof;

FIG. 11 is a front view of a dough divider comprising a second embodiment of the invention in which certain component parts have been broken away more fully to illustrate the construction and operation thereof;

FIG. 12 is a side view of the dough divider of FIG. 11 in which certain component parts have been broken away more fully to illustrate the construction and operation thereof;

FIG. 13 is a side view of a cut off head which may be utilized in the practice of the invention in lieu of the cut off head shown in FIGS. 3, 4, and 5;

FIG. 14 is a sectional view further illustrating the cut off head of FIG. 13;

FIG. 15 is a bottom view of the cut off head of FIG. 13;

FIG. 16 is a flowchart illustrating a method of controlling the pressure of the dough within the pressurizing chamber of the dough divider illustrated in FIGS. 1 and 2; and

FIG. 17 is a flowchart illustrating a method of operating of the cutoff head illustrated in FIGS. 3, 4, and 5 and the metering pump Illustrated In FIGS. 7, 8, and 9.

### DETAILED DESCRIPTION

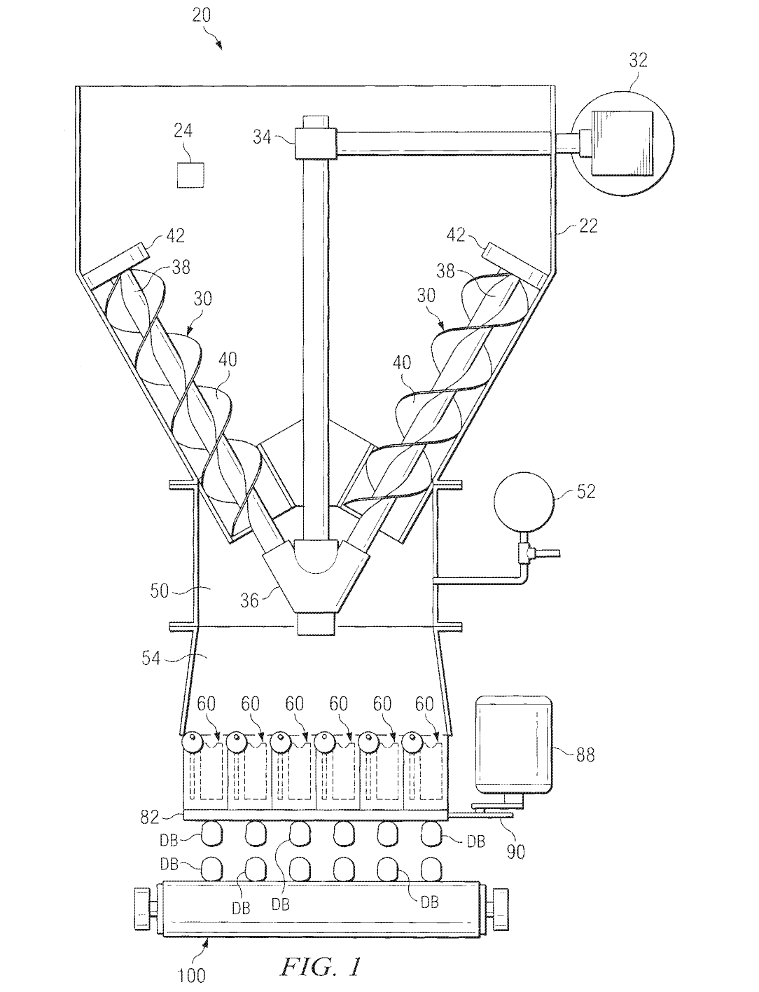

Referring to the drawings, and in particular to FIGS. 1-6, inclusive, a dough divider 20 comprising a first embodiment of the invention is illustrated. The dough divider 20 includes a dough receiving hopper 22. Dough is transported from a dough mixer (not shown) into the hopper 22 by a pump or other device (not shown) and one or more dough transporting conveyors (not shown). A transmitter 24 located adjacent the top of the hopper 24 controls the flow of dough into the dough divider 20.

One or more augers 30 are mounted within the hopper 22 for actuation by a drive motor 32 and a drive train including a right angle drive 34 and a bevel drive 36. Each auger 30 includes an auger shaft 38, an auger flight 40, and a wheel 42 secured to the distal end of the auger shaft 38. As will be appreciated by those skilled in the art as the hopper 22 of the dough divider 20 is filled, the wheel(s) 42 comprising the auger(s) 40 are lifted out of engagement with the side wall of the hopper 22 by resistance of the dough. However, at the end of a run of dough the transmitter 24 is deactivated and the flow of dough into the hopper 22 is terminated. As the level of dough in the hopper 22 falls below the level of the wheel (s) 42 the wheel (s) engage the side wall of the hopper 22 whereupon the auger(s) travel circumferentially around the side wall of the hopper 22. In this manner the side wall of the hopper 22 is swept completely clear of dough at the end of a dough run.

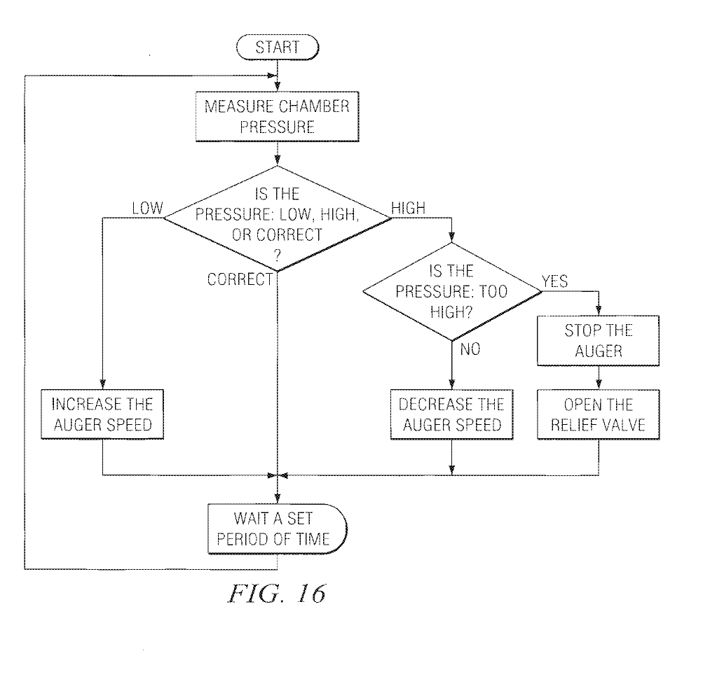

The function of the auger(s) 30 is to force dough downwardly from the hopper 22 into a pressurizing chamber 50. Referring simultaneously to FIGS. 1, 2, and 16, a transmitter 52 monitors the pressure within the pressurizing chamber 50. The speed of operation of the auger(s) 30 is regulated in accordance with the pressure within the chamber 50 with the speed of operation of the auger(s) 30 being increased if the operating pressure in the chamber 50 is too low and decreased if the operating pressure within the chanter 50 is too high. A relief valve may be provided for reducing the pressure of the dough within the pressurizing chamber 50 if the speed of operation of the auger(s) 30 cannot be reduced sufficiently to do so. From the pressurizing chamber 55 the now degassed dough flows into a manifold 54 which functions to distribute the dough evenly to a plurality of cut off heads 60.

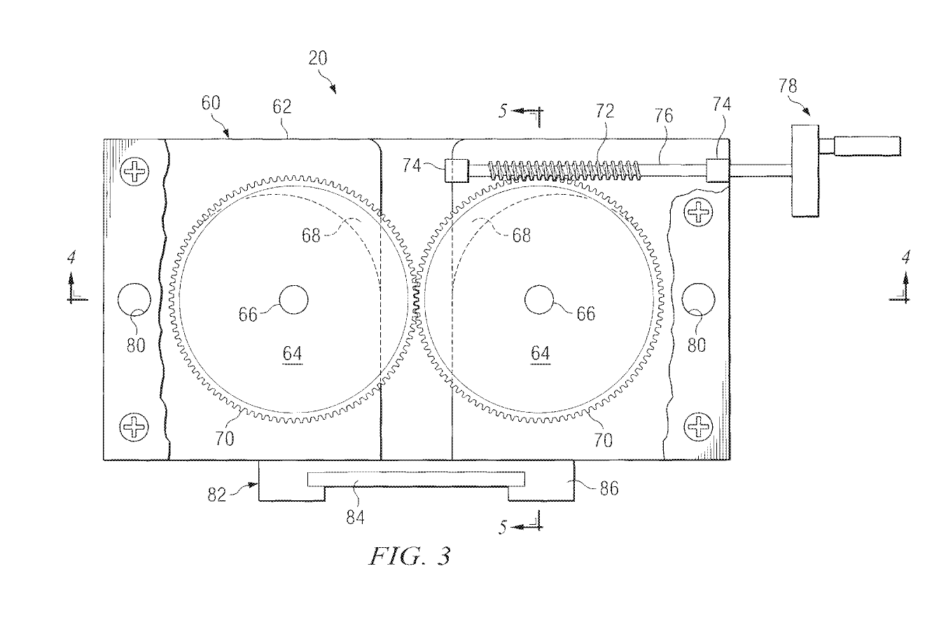

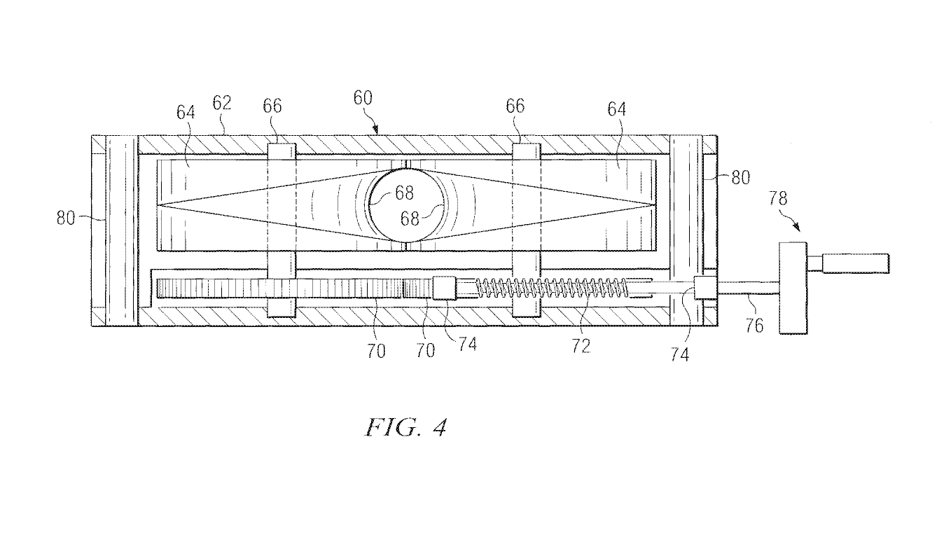

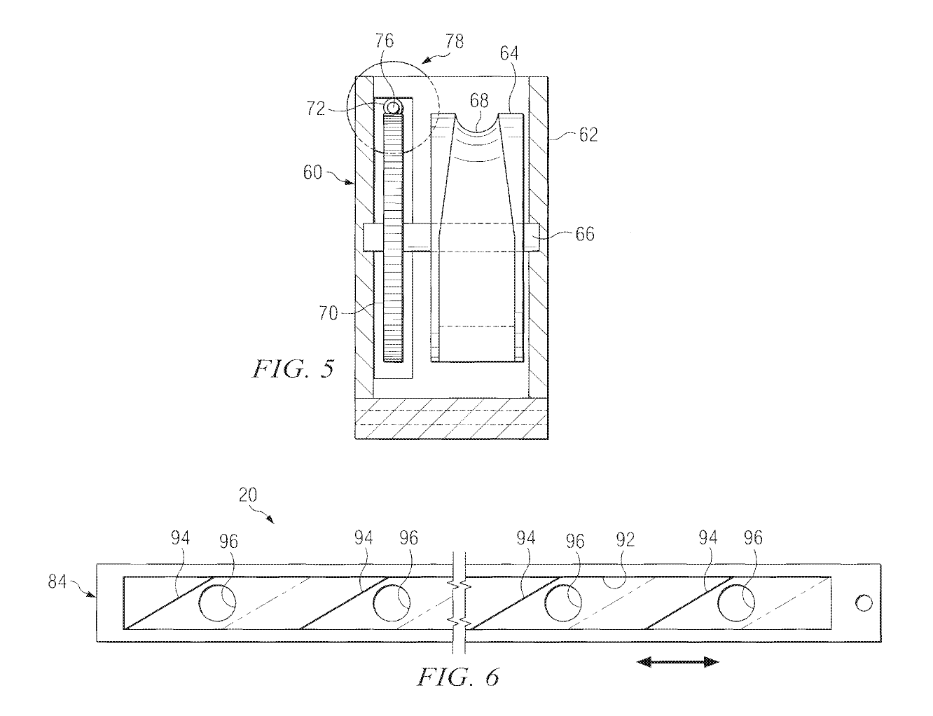

The construction and operation of the cut off heads 60 is illustrated in FIGS. 3, 4, and 5. Each cut off head 60 comprises a frame 62 having a pair of identical but oppositely configured cut off wheels 64 rotatably supported therein by a pair of shafts 66. Referring particularly to FIG. 5 each of the cut off wheels 64 has a semicircular groove 68 formed therein. Each semicircular groove 68 is defined by a continuously varying diameter extending from a fully open configuration at one end to a fully closed configuration at the opposite end. As will therefore be understood by those skilled in the art, depending upon the relative positioning thereof the semicircular grooves 63 of the cut off wheels 64 create a dough flow controlling aperture which is both infinitely variable and continuously perfectly circular.

Referring to FIGS. 3 and 4, each of the shafts 66 has a precision gear 70 secured thereto. A worm gear 72 is rotatably supported on the frame 62 by bearings 74 and is mounted in mesh with one of the precision gears 70. The shaft 76 of the worm gear 72 extends to a micrometer-type handle 78 which actuates the worm gear 72 to rotate the gears 70 thereby positioning the cut off wheels 70 to position the semicircular grooves 68 at precisely the locations required to provide a discharge diameter which precisely matches the requirements of any particular utilization of the dough divider 20.

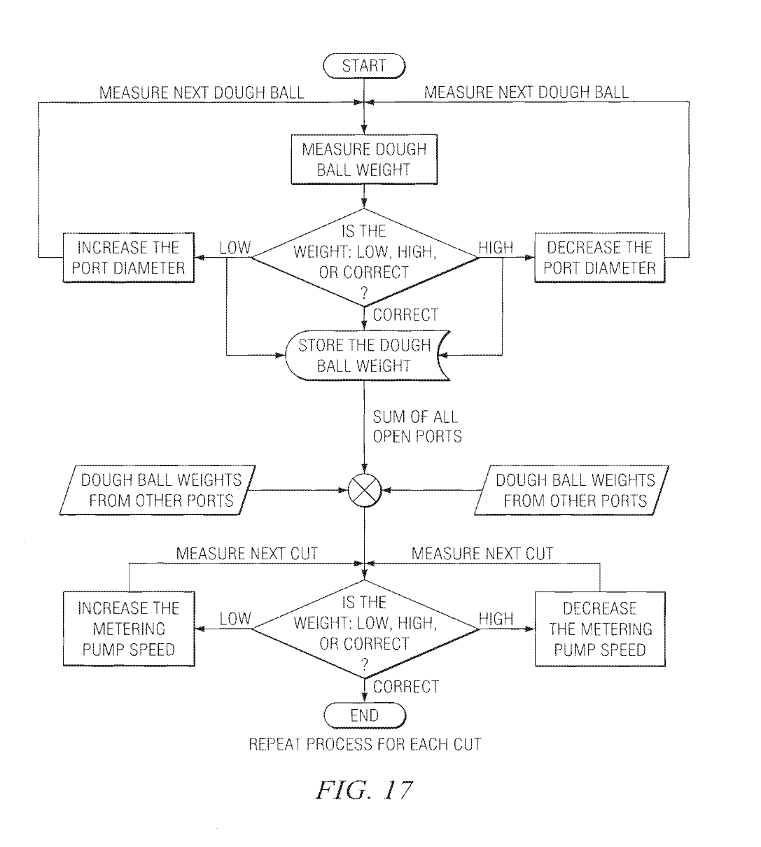

In lieu of the handle 78 a servo system responsive to the weight of the dough balls formed by the dough divider 20 may be employed to control the rotational positioning of the shaft 76 thereby precisely controlling the positioning of the semicircular grooves and ultimately the weight of the dough balls formed by the dough divider 20. The upper portion of FIG. 17 comp, rises a flowchart illustrating a method of operating the servo system to control the weight of the dough balls formed by the dough divider 20.

Referring to FIGS. 1, 3, and 4, the dough divider 20 comprises a plurality of cut off heads 60, it being understood that the number thereof depends upon the requirements of particular applications of the invention. The cut off heads 60 are positioned in a side by side relationship and extend across the entirety of the discharge end of the manifold 54. Referring particularly to FIGS. 3 and 4, a pair of rods (not shown) are extended through aligned apertures 80 formed in the frames 62 of the cut off heads 60 thereby maintaining the cut off heads 60 in precise alignment with one another. With the cut off heads properly aligned each of the handles 78 is manipulated until all of the cut off heads 60 produce streams of dough that are substantially identical in diameter.

Referring to FIGS. 1, 2, 4, and 6 a dough cut off mechanism 82 is positioned directly beneath the cut off heads 60. A slider 84 is positioned for reciprocation in a track 86. A motor 88 operates an eccentric mechanism 90 which reciprocates the slider 84 relative to the track 86.

Referring particularly to FIG. 6 the slider 84 has a rectangular aperture 92 formed therein. A plurality of lengths of piano wire or knife blades or other cutting devices 94 extend across the aperture 92 and are maintained in a taut condition. As the slider 84 is reciprocated under the action of the motor 88 and the eccentric 90 the cutting devices 94 move between the positions shown in full lines and the positions shown in dashed lines in FIG. 6 thereby moving fully across the discharge apertures 96 of the cut off heads 60 on each reciprocation.

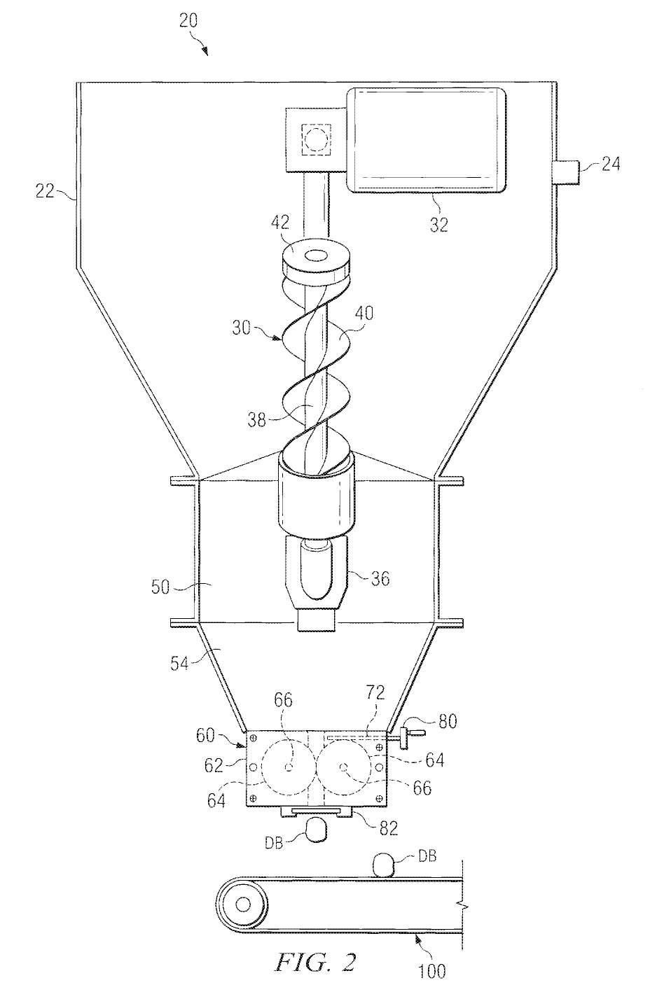

Referring to FIGS. 1 and 2 the cut off heads 60 comprising the dough divider 20 function to form streams of dough having individually controlled diameters. The cut off mechanism 82 severs the streams of dough at precise intervals thereby forming dough balls DE which are substantially identical in weight. The dough balls DB are received by a conveyor 100 which transports the dough balls DB to subsequent dough processing devices particularly including a dough rounder.

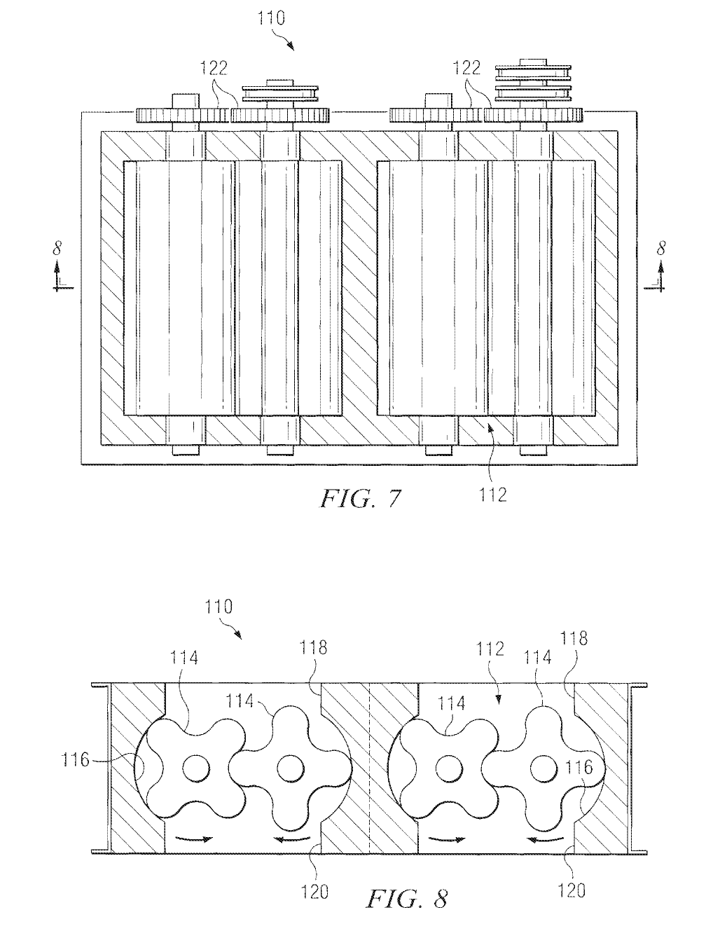

FIGS. 7, 8, and 9 illustrate a metering pump 110 useful in the practice of the invention. The metering pump 110 does not function to increase the pressure of the dough flowing therethrough but instead functions to control the flow of dough into the cut off heads 60. Although the metering pump 110 comprises a double cavity metering pump those skilled in the art will appreciate the fact that the metering pump 110 may comprise whatever number of cavities is best suited for any particular application of the invention.

Each cavity 112 comprising the metering pump 110 comprises a pair of four-lobed impellers 114 mounted in mesh with one another which rotate with n a cavity 116. Dough enters the metering pump 110 through an inlet aperture 118 as a result of the pressure in the pressurizing chamber 50 and is discharged from the discharge pump 110 through a metering aperture 120.

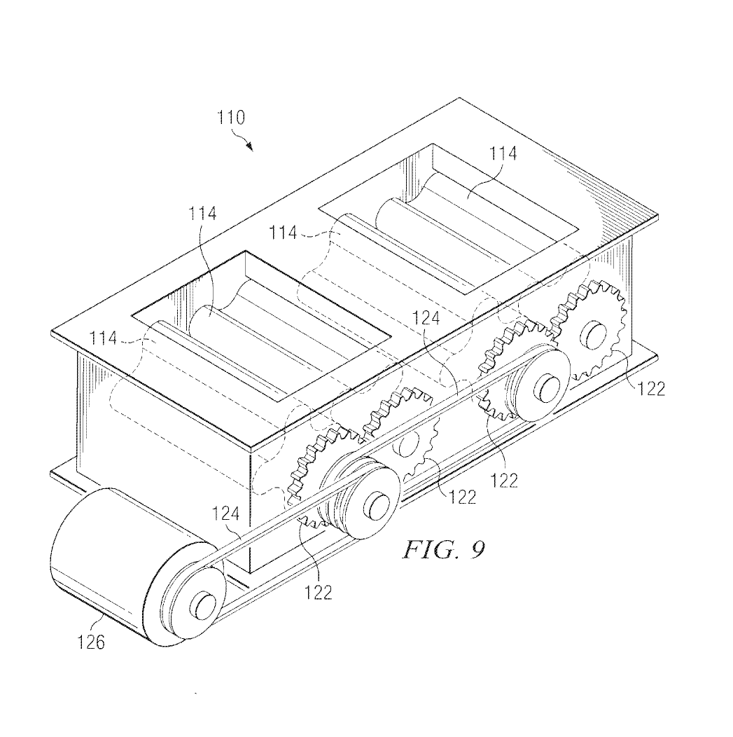

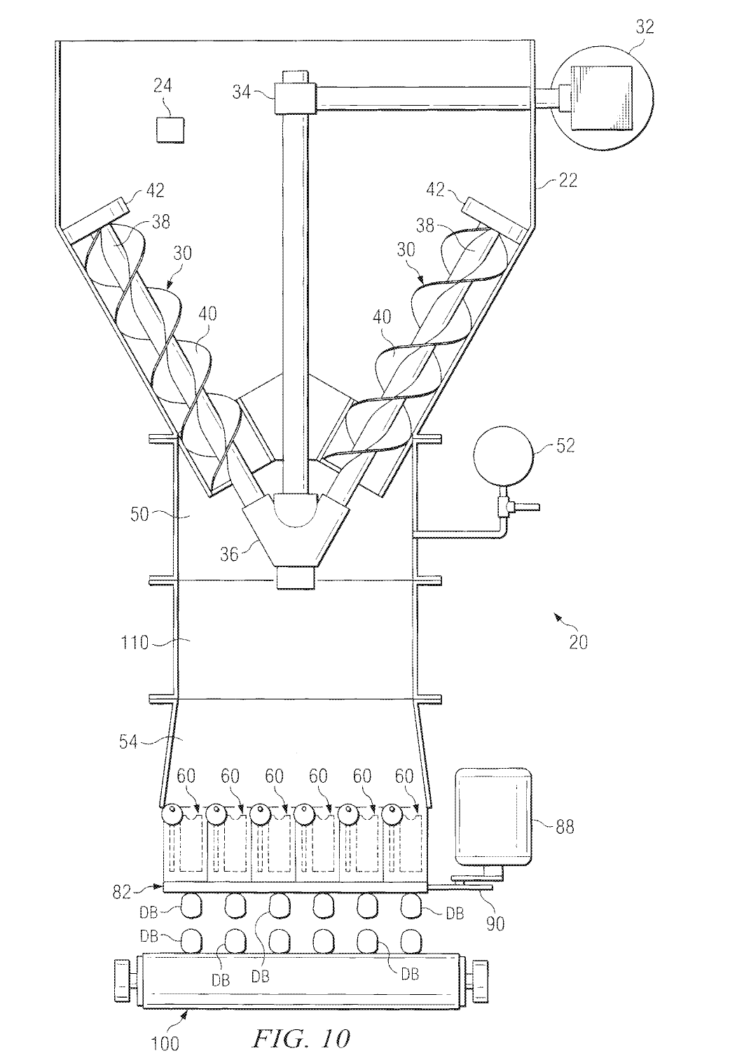

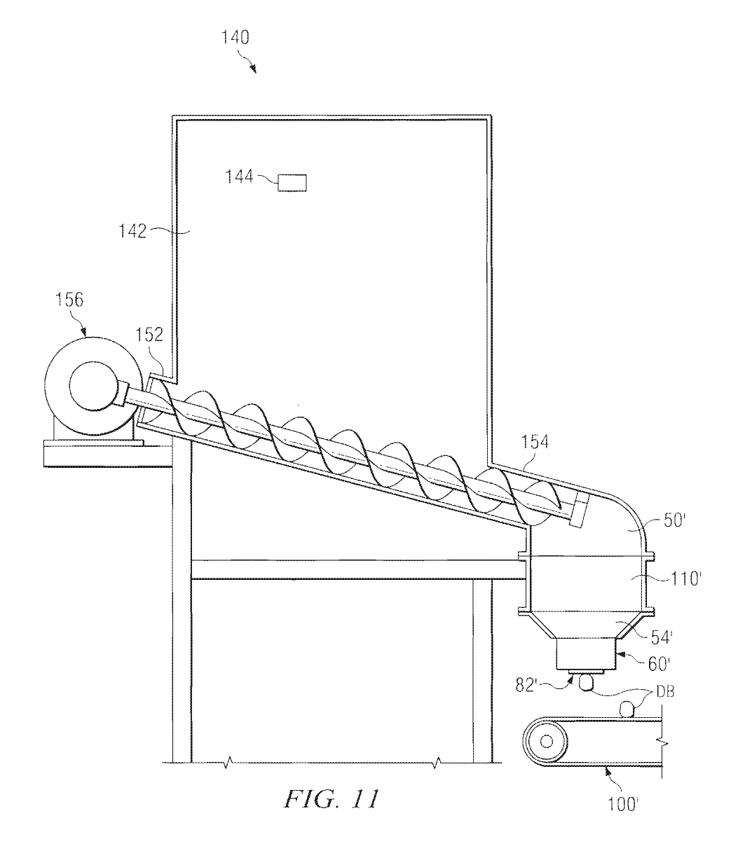

Referring particularly to FIGS. 7 and 9, the impellers 114 are driven by precision gears 122 thereby maintaining the correct angular relationship between the two impellers 114 comprising the metering pump and thereby assuring a continuous seal therebetween. Referring particularly to FIG. 9, the gears 122 are driven by pulleys 124 which are in turn driven by a variable speed motor 126. FIG. 10 illustrates the dough divider 20 illustrated in FIGS. 1-6, inclusive, and described hereinabove in conjunction therewith having the metering pump 110 positioned between the pressure chamber 50 and the manifold 54. The bottom portion of FIG. 17 comprises a flowchart illustrating a method of operating a servo system or controlling the operation of the metering pump 110. As will be understood by those skilled in the art, FIG. 17 in its entirety illustrates a method of assuring that all of the cutoff heads produce dough balls of equal weight.

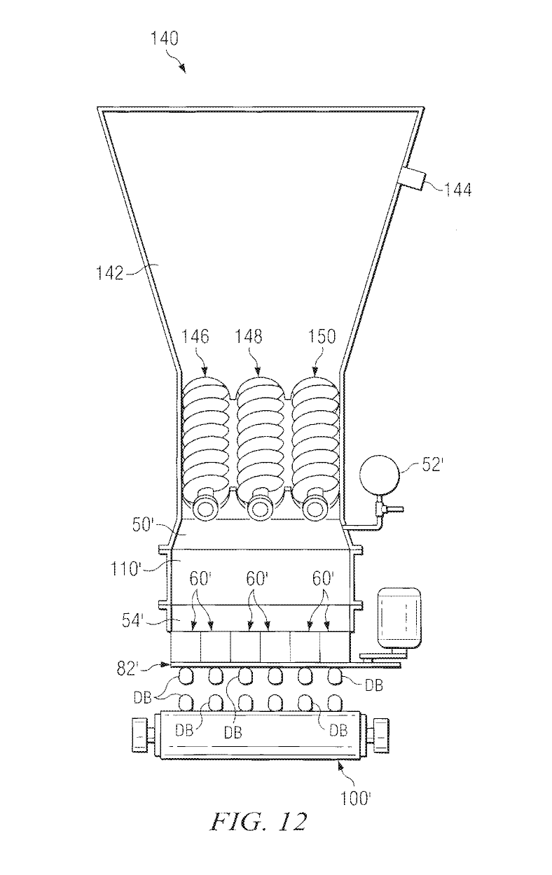

A dough divider 140 comprising a second embodiment of the invention is illustrated in FIGS. 11 and 12. The dough divider 140 includes a hopper 142 which receives dough from a source thereof including a mixer, a pump, and one or more conveyors. A transmitter 144 mounted within the hopper 142 may be employed to maintain the quantity of dough within the hopper 142 at a predetermined level.

The dough divider 140 further comprises three augers 146, 148, and 150. The augers 146, 148, and 159 are located at the bottom of the hopper 142 and define a live bottom thereof. Referring particularly to FIG. 11, each of the augers 146, 148, and 150 is received in conduits 152 and 154 located at the upper and lower ends thereof, respectively, and is driven by an individual drive motor 156 one or more of which may be a variable speed drive motor.

Referring simultaneously to FIGS. 11 and 12, the augers 146, 148, and 153 deliver dough from the hopper 142 into a pressurizing chamber 50′ which corresponds in construction and function to the pressurizing chamber 50 of the dough divider 20 as illustrated in FIGS. 1 and 2 and described hereinabove in conjunction therewith. The pressurizing chamber 50′ is provided with a transmitter 52e which corresponds to the transmitter 52 of the dough divider 20 as illustrated in FIG. 1 and described hereinabove in conjunction therewith.

The three augers 146, 148, and 150 operate continuously. The speed of operation of the augers is regulated by the output of the transmitter 2. If the three augers cannot maintain adequate pressure in the pressurizing chamber 50′ the speed of the augers is increased.

The dough divider 140 may be provided with a metering pump 110′ which is identical in construction and function to the metering pump 110 illustrated in FIGS. 7, 3, and 9 and described hereinabove in conjunction therewith. If used the metering pump 110′ directs dough into a manifold 54′ which is substantially identical in construction and function to the manifold 54 illustrated in FIGS. 1 and 2 and described hereinabove in con-unction therewith. As will be appreciated by those skilled in the arm, many applications of the invention do not require the use of the metering pump 110′ in which case the manifold 54′ is connected directly to the pressurizing chamber 54′ in the same manner that the manifold 54 of the dough divider 20 is connected to the pressurizing chamber 50 thereof as illustrated in FIGS. 1 and 2 and described hereinabove in conjunction therewith.

The manifold 54′ directs dough uniformly into a plurality of cut off heads 60′ which are identical in construction and function to the cut off heads 60 of the dough divider 20 as illustrated in FIGS. 3, 4, and 5 and described hereinabove in conjunction therewith. The cut off heads 60′ direct substantially identical streams of dough to a cut off knife assembly 82′ which is identical in construction and function to the cut off knife assembly 82 of the dough divider 20 as illustrated in FIGS. 1, 2, and 6 and described hereinabove in conjunction therewith. The cut off knife assembly 82′ severs the streams of dough flowing from the cut off heads 60′ into a plurality of dough balls DB which fall onto a conveyor 100′ which is substantially identical in construction and function as the conveyor 100 as illustrated in FIGS. 1 and 2 and described hereinabove in conjunction therewith.

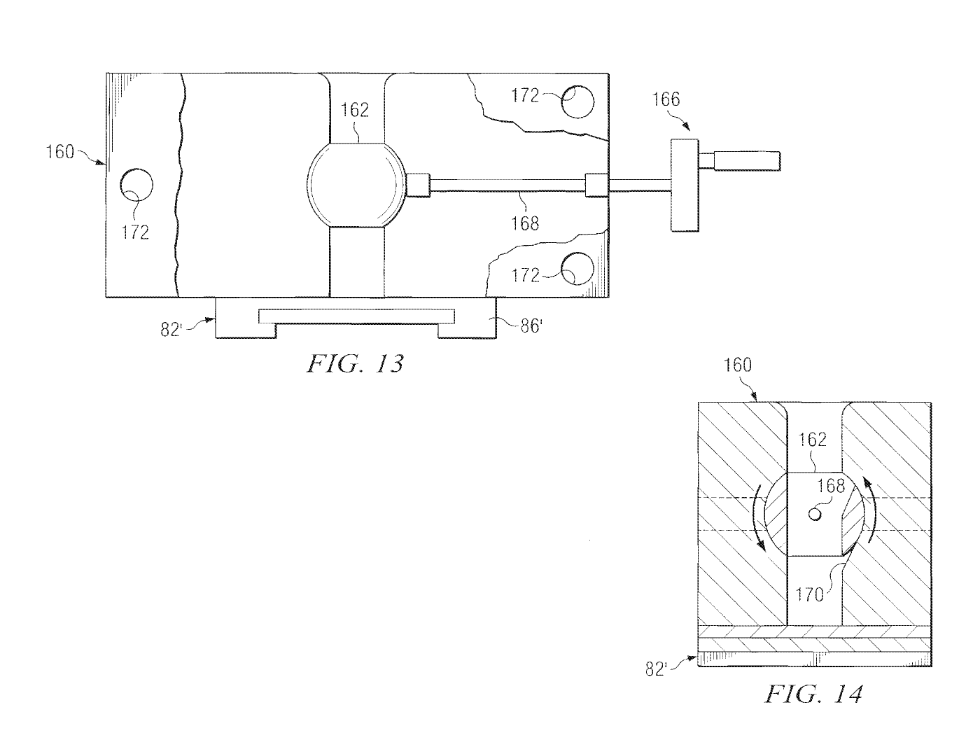

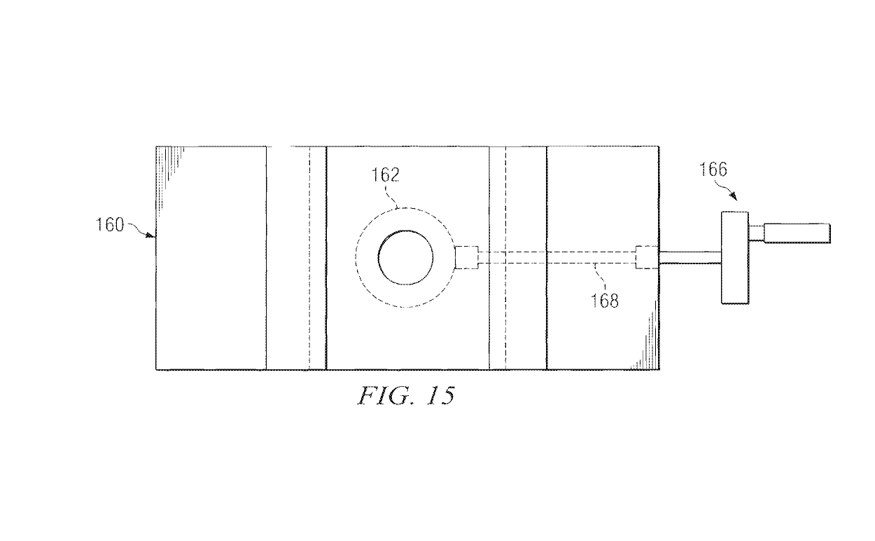

FIGS. 13, 14, and 15 illustrate a cut off head 160 which may be utilized in the practice of the invention in lieu of the cut off head 160 as illustrated in FIGS. 1-5, inclusive, and described hereinabove in conjunction therewith. The cut off head 160 comprising a modified ball valve 162 which fine tunes the flow of dough through the cut off head 160 and also serves as a shut off valve. Dough cannot be forced through a valve that presents sharp, protrusions or obstacles that might tear the dough. Therefore, ball valve 162 is modified as shown at 164 to relieve sharp edges as the valve 162 is rotated under the action of a handle 166 and a shaft 168. The seas 170 of the ball valve 162 is also relieved to prevent sharp edges as the ball is rotated. Similar to the mounting of the cut off heads 60 as illustrated in FIGS. 1-5 and particularly as illustrated in FIG. 4 a plurality of cut off heads 160 may be mounted side by side and maintained in proper alignment by rods which are extended through passageways 172.

Although preferred embodiments of the invention have been illustrated in the accompanying Drawings and described in the foregoing Detailed Description, it will be understood that the invention is not limited to the embodiments disclosed, but is capable of numerous rearrangements, modifications and substitutions of parts and elements without departing from the spirit of the invention.

1. A dough divider comprising:
a hopper for receiving a quantity of dough;
the hopper having a discharge outlet;
at, least one auger mounted within the hopper and extending into the discharge outlet thereof;
means for rotating the auger relative to the hopper and thereby forcing dough from the hopper through the outlet thereof;
a pressurizing chamber positioned directly below the hopper for receiving pressurized dough from the hopper under the action of the auger;
means for determining the pressure of the dough within the pressurizing chamber;
means for regulating the speed of operation of the auger in response to the pressure of the dough within the pressurizing chamber;
a manifold positioned directly below the pressurizing chamber for receiving dough therefrom;
a plurality of cut of heads positioned directly below the manifold for receiving dough therefrom;
the manifold for distributing dough uniformly to each of the cut off heads;
the cut off heads for producing a plurality of dough streams having individually regulated diameters;
a cut off knife assembly for cutting the dough streams formed by the cut off heads into substantially equal length dough balls; and
whereby the dough divider produces dough balls that are substantially identical in weight.
